(19) United States
(12) Patent Application Publication
(10) Pub. No.: US 2006/0073981 A1
(43) Pub. Date: Apr. 6, 2006

(54) Methods of preparing non-aqueous fluids suitable for use in wellbore servicing fluids

(76) Inventor: Jeffery C. Gee, Kingwood, TX (US)

Correspondence Address: CHEVRON PHILLIPS CHEMICAL COMPANY, 5700 GRANITE PARKWAY, SUITE 330, PLANO, TX, 75024-6616, US

(21) Appl. No.: 10/959,739

(22) Filed: Oct. 6, 2004

(51) Int. Cl. C09K 8/32; E21B 43/00

(52) U.S. Cl. 507/103

(57) ABSTRACT

A method of decreasing the toxicity, as determined according to ASTM E 1367-92, of a non-aqueous fluid for use in a wellbore servicing fluid, comprising providing a starting non-aqueous fluid having a toxicity of about equal to or greater than a toxicity of a reference standard non-aqueous fluid, and adding an effective amount of one or more additive non-aqueous fluids to the starting non-aqueous fluid to produce a blended non-aqueous fluid having a toxicity of less than the toxicity of the reference standard non-aqueous fluid. In an embodiment, the blended fluid has a biodegradability of about equal to or greater than a biodegradability of the reference standard fluid as measured according to ISO 11734. The starting fluid may comprise C₁₆ internal olefins, C₁₈ internal olefins, or combinations thereof. The additive fluid may comprise one or more esters, C₂₀ internal olefins, C₂₂ internal olefins, C₂₄ internal olefins, or combinations thereof.

### CROSS-REFERENCE TO RELATED APPLICATIONS

Not Applicable.

### STATEMENT REGARDING FEDERALLY SPONSORED RESEARCH OR DEVELOPMENT

Not applicable.

### REFERENCE TO A MICROFICHE APPENDIX

Not applicable.

### FIELD OF THE INVENTION

The present disclosure generally relates to methods of preparing non-aqueous fluids suitable for use in wellbore servicing fluids, for example, as a base fluid for a drilling fluid, more specifically as the continuous phase in an invert, e.g., a water-in-oil, emulsion drilling fluid or mud.

### BACKGROUND OF THE INVENTION

In performing wellbore servicing operations to facilitate the recovery of hydrocarbons from subterranean formations, a wellbore servicing fluid used in such operations may be exposed to the environment. For example, in offshore drilling, a drilling fluid may come into contact with ocean water during the drilling process. Various environmental regulations throughout the world regulate the exposure of wellbore servicing fluids to the environment in an effort to minimize pollution. As these environmental regulations change or become more restrictive, an ongoing need exists for improved, environmentally friendly non-aqueous fluids suitable for use in wellbore servicing fluids.

### SUMMARY OF THE INVENTION

Disclosed herein is a method of decreasing the toxicity, as determined according to ASTM E 1367-92, of a non-aqueous fluid for use in a wellbore servicing fluid, comprising providing a starting non-aqueous fluid having a toxicity of about equal to or greater than a toxicity of a reference standard non-aqueous fluid, and adding an effective amount of one or more additive non-aqueous fluids to the starting non-aqueous fluid to produce a blended non-aqueous fluid having a toxicity of less than the toxicity of the reference standard non-aqueous fluid.

Further disclosed herein is a method of blending a non-aqueous base fluid for an invert emulsion drilling fluid, comprising providing a starting non-aqueous fluid, and adding one or more additive non-aqueous fluids to the starting non-aqueous fluid to produce a blended non-aqueous fluid; wherein the one or more additive non-aqueous fluids has a molecular weight of equal to or greater than a molecular weight of the starting non-aqueous fluid, and the blended non-aqueous fluid has a biodegradability of about equal to or greater than a biodegradability of the starting non-aqueous fluid as measured according to ISO 11734.

Further disclosed herein is a method of improving environmental performance of a non-aqueous base fluid for an invert emulsion offshore drilling fluid, comprising providing a starting non-aqueous fluid, and adding one or more additive non-aqueous fluids to the starting non-aqueous fluid to produce a blended non-aqueous fluid, wherein the blended non-aqueous fluid has a toxicity of about less than a toxicity of the starting non-aqueous fluid as measured according to ASTM E 1367-92, and the blended non-aqueous fluid has a biodegradability of about equal to or greater than a biodegradability of the starting non-aqueous fluid as measured according to ISO 11734.

Further disclosed herein is a method of blending a non-aqueous base fluid for an invert emulsion drilling fluid, comprising providing a neat non-aqueous fluid consisting essentially of C_{16/18} internal olefins, and adding an effective amount of C_{20/24} internal olefins to the neat non-aqueous fluid such that a resultant blended non-aqueous fluid is less toxic than the neat non-aqueous fluid as measured according to ASTM E 1367-92.

Further disclosed herein is a method of decreasing the toxicity of a non-aqueous base fluid for an invert emulsion drilling fluid, comprising determining a baseline toxicity according to ASTM E 1367-92 for a non-aqueous base fluid consisting essentially of C_{16/18} internal olefins, and adding an effective amount of C_{20/24} internal olefins to the non-aqueous base fluid such that a resultant blended non-aqueous fluid is less toxic than baseline toxicity of the non-aqueous base fluid.

Further disclosed herein is a non-aqueous fluid blend for use as a continuous phase in an invert emulsion drilling fluid, comprising from about 85 to less than 100 weight percent C_{16/18} internal olefins, and from greater than 0 to about 15 weight percent C_{20/24} internal olefins, wherein the blend is less toxic than the C_{16/18} internal olefins as measured according to ASTM E 1367-92.

### DETAILED DESCRIPTION OF THE PREFERRED EMBODIMENTS

Disclosed herein are methods of preparing non-aqueous fluids suitable for use in wellbore servicing fluids, for example, as a base fluid for a drilling fluid, more specifically as the continuous phase in an invert, e.g., a water-in-oil, emulsion drilling fluid or mud. As used herein, “non-aqueous” refers to a fluid that is substantially free of water, consists essentially of compounds other than water, or includes very little water, for example equal to or less than about 10% water by weight of the non-aqueous fluid, alternatively equal to or less than about 5% water, alternatively equal to or less than about 1% water. In various embodiments, the non-aqueous fluids comprise one or more liquid hydrocarbons, one or more water insoluble organic chemicals, or combinations thereof. In various embodiments, a blended, non-aqueous base fluid product (referred to herein as a blended fluid) is prepared by blending a starting non-aqueous base fluid (referred to herein as a starting base fluid and commonly known as a stock base fluid or a neat base fluid) with one or more additional non-aqueous fluids (referred to herein as additive fluids).

The blended fluid may be prepared by adding an effective amount of one or more additive fluids to the starting base fluid to improve the toxicity of the starting base fluid, to maintain or improve the biodegradability of the starting base fluid, or both. An effective amount may be determined by incrementally increasing the amount of the additive fluids in one or more starting base fluid samples and testing the resultant blended fluid until acceptable toxicity, biodegradability, or both are achieved. In an embodiment, the blended fluid is prepared by adding an effective amount of one or more additive fluids to the starting base fluid to decrease the toxicity of the starting base fluid. In an embodiment, the toxicity of the blended fluid and components thereof, e.g., the starting base fluid and additive fluids, is determined according to ASTM E 1367-92, also known as EPA 66 FR 65209, and described in more detail herein. In an embodiment, the toxicity of the blended fluid and/or the components thereof are compared to the toxicity of a reference standard non-aqueous fluid (referred to herein as a reference fluid), for example a fluid designated by a governmental or regulatory agency as exhibiting acceptable toxicity for exposure to the environment such as during offshore drilling. In an embodiment, the starting fluid has a toxicity of about equal to or greater than the toxicity of the reference fluid and the blended fluid has a toxicity of about less than the toxicity of the reference fluid. In an embodiment, the starting fluid has a toxicity of about equal to or greater than the toxicity of the reference fluid and the additive fluids and blended fluid each have a toxicity of about less than the toxicity of the reference fluid. In an embodiment, the starting fluid comprises the reference fluid, for example the starting fluid and the reference fluid may be the same, and the blended fluid has a toxicity of about less than the toxicity of the starting fluid.

In an embodiment, the blended fluid is prepared by adding an effective amount of one or more additive fluids to the starting base fluid to maintain or improve the biodegradability of the starting base fluid. In an embodiment, the biodegradability of the blended fluid and components thereof, e.g., the starting base fluid and additive fluids, is an anaerobic biodegradability as determined according to modified ISO 11734, also known as EPA 66 FR 65209, and described in more detail herein. In an embodiment, the biodegradability of the blended fluid and/or the components thereof is compared to the biodegradability of the reference fluid. In an embodiment, the blended fluid has a biodegradability, e.g., an anaerobic biodegradability, of about equal to or greater than the biodegradability of the starting fluid. In an embodiment, the starting fluid comprises the reference fluid, for example the starting fluid and the reference fluid may be the same, and the blended fluid has a biodegradability of about equal to or greater than the biodegradability of the reference fluid.

The starting base fluid may be any non-aqueous base fluid known to those skilled in the art. In one embodiment, the starting base fluid is a synthetic hydrocarbon (i.e., synthetic starting base fluids). Useful synthetic hydrocarbons include linear-α-olefins, polyalphaolefins (unhydrogenated or hydrogenated), internal olefins, esters, or combinations thereof. In an embodiment, the starting base fluid has a toxicity of about equal to or greater than the toxicity of the reference fluid. In an embodiment, the starting base fluid has a biodegradability of about equal to or less than the biodegradability of the reference fluid. In an embodiment, the starting base fluid may be a mixture of non-aqueous fluids

In some embodiments, the starting base fluid comprises one or more linear alpha olefins having from 14 to 30 carbon atoms. Starting base fluids comprising one or more linear alpha olefins having from 14 to 30 carbon atoms are described in U.S. Pat. No. 5,432,152, which is incorporated by reference herein in its entirety. In other embodiments, the starting base fluid comprises of a mixture of internal predominately linear tetradecene isomers and internal predominately linear hexadecene isomers as described in U.S. Pat. No. 6,323,157, which is incorporated by reference herein in its entirety. In other embodiments, the starting base fluid comprises a mixture of a linear aliphatic alkane combined with a branched chain aliphatic alkane as described in U.S. Pat. No. 5,569,642, which is incorporated by reference herein in its entirety.

In an embodiment, the starting base fluid is an environmentally friendly fluid as is known in the art, more specifically an environmentally friendly synthetic starting base fluid. In an embodiment, the starting base fluid comprises C₁₆ internal olefins, C₁₈ internal olefins, or combinations thereof. In other embodiments, the starting base fluid consists essentially of C_{16/18} internal olefins. Examples of commercially available starting base fluids include C_{16/18} isomerized olefins (also known as C_{16/18} internal olefins) available from Chevron Phillips Chemical Company LLC (CPChem) of The Woodlands, Tex. In an embodiment, the starting base fluid comprises internal olefins, for example C_{16/18} internal olefins (IO). Such internal olefins may be produced via isomerization of alpha-olefins, also referred to as isomerized olefins, or may be produced by any other suitable method. Examples of suitable isomerized olefins and methods of making same are described in U.S. Pat. Nos. 5,589,442, 6,057,272, 6,054,415, 5,965,783 and 5,741,759, each of which is incorporated by reference herein in its entirety.

In an embodiment, the starting base fluid, the reference fluid, or both comprise about 65 weight percent C₁₆ internal olefins, more specifically hexadecenes identified by CAS # 26952-14-7, and about 35 weight percent C₁₈ internal olefins, more specifically octadecenes identified by CAS # 27070-58-2, referred to herein as a 65:35 C_{16/18} IO. In an embodiment, the starting base fluid, the reference fluid, or both are a 65:35 C_{16/18} isomerized alpha-olefin fraction available from CPChem and having specifications set forth in Tables I and II.

TABLE I
Specifications for 65:35 C_{16/18} IO

| | | SPECIFI- |
|---|---|---|
| CHARACTERISTIC | METHOD | CATION |
| Carbon Number, wt. % C₁₄, max. | GLC | 1.7 |
| Carbon Number, wt. % C₁₆ | GLC | 62.5-67.5 |
| Carbon Number, wt. % C₁₈ | GLC | 32.5-37.5 |
| Carbon Number, wt. % ≧C₂₀, max. | GLC | 4.0 |
| Kinematic Viscosity @ 0 C., | ASTM D 445 | 7.5-8.0 |
| cSt, min.-max. | | |
| Kinematic Viscosity @ 40 C., | ASTM D 445 | 2.8-3.5 |
| cSt, min.-max. | | |
| Kinematic Viscosity @ 100 C., | ASTM D 445 | 1.1-1.5 |
| cSt, min.-max. | | |
| Pour Point, ° F. (C.) | ASTM D 97 | ≦15° F. (−10 C.) |
| n-Alpha Olefin, wt. %, max. | FTIR | 6.0 |
| Water, ppm by wt., max. | ASTM D 1744 | 100 |
| Color, Saybolt, min. | ASTM D 6045 | +20 |
| Appearance | ASTM D 4176 | Clear & Bright |

TABLE II
Specifications for 65:35 C_{16/18} IO

| | | TYPICAL |
|---|---|---|
| CHARACTERISTIC | METHOD | VALUE |
| Carbon Number, wt. % C₁₄ | GLC | 0.2 |
| Carbon Number, wt. % C₁₆ | GLC | 64.0 |
| Carbon Number, wt. % C₁₈ | GLC | 35.0 |
| Carbon Number, wt. % ≧C₂₀ | GLC | 0.8 |
| Kinematic Viscosity @ 0 C., | ASTM D 445 | 7.7 |
| cSt | | |
| Kinematic Viscosity @ 40 C., | ASTM D 445 | 2.9 |
| cSt | | |
| Kinematic Viscosity @ 100 C., | ASTM D 445 | 1.3 |
| cSt | | |
| Density @60° F. (15.6 C.), lb/gal | ASTM D 4052 | 6.5-6.7 |
| API Gravity | ASTM D 4052 | 45-50 |
| Color, Saybolt | ASTM D 6045 | +25 |
| Flash Point, ° F. (C.) | ASTM D 93 | 288° F. (142 C.) |

In an embodiment, the additive fluid may be any non-aqueous fluid which has a toxicity less than the toxicity of the reference fluid. In another embodiment, the additive fluid may be any non-aqueous fluid that has an anerobic biodegradability greater than the anerobic biodegradability of the reference fluid. Alternatively, the additive fluid may have a toxicity less than the toxicity of the reference fluid and an anerobic biodegradability greater than the anerobic biodegradability of the reference fluid. In an embodiment, the additive fluid has a weight average molecular weight equal to or greater than the molecular weight of the starting base fluid. In another embodiment, the additive fluid has a weight average molecular weight equal to or greater than the molecular weight of the reference fluid.

The additive fluid may be added to the starting base fluid in any amount that provides for the desired toxicity, desired anaerobic biodegradability, or both. In some embodiments, the additive fluid comprises from greater than 0 to about 50 weight percent of the blended fluid. In other embodiments, the additive fluid comprises from greater than 0 to about 40 weight percent of the blended fluid. Alternatively, the additive fluid comprises from greater than 0 to about 25 weight percent of the blended fluid. In yet other embodiment, the additive fluid comprises greater than 0 to about 15 weight percent of the blended fluid. In yet still other embodiment, the additive fluid comprises greater than 0 to about 10 weight percent of the blended fluid.

In various embodiments, the additive fluid may comprise one or more internal olefins, esters, or combinations thereof. In some embodiments, the additive fluid comprises olefins having at least 20 carbon atoms. In an embodiment, the additive fluid comprises olefins having a weight average molecular weight equal to or greater than the molecular weight of the starting base fluid. In an embodiment, the additive fluid comprises C₂₀ IO, C₂₂ IO, C₂₄ IO, or combinations thereof. In one embodiment the additive fluid is C_{20/24} IO. Typically, the C_{20/24} IO comprises from about 35 to about 55 weight percent C₂₀ IO, from about 25 to about 45 weight percent C₂₂ IO, and from about 8 to about 30 weight percent C₂₄ IO. In an embodiment, the C_{20/24} IO comprises equal to or less than about 35 weight percent branched olefins, alternatively equal to or less than about 30 weight percent branched olefins. The blended fluid may comprise from greater than 0 to about 20 weight percent C_{20/24} IO, alternatively from greater than 0 to about 15 weight percent C_{20/24} IO, alternatively from greater than 0 to about 10 weight percent C_{20/24} IO, alternatively from greater than 0 to about 5 weight percent C_{20/24} IO.

In an embodiment, the additive fluid comprises one or more esters, for example synthetic esters, natural esters, or combinations thereof. In an embodiment, the additive fluid may comprise one or more primary esters, secondary esters, or combinations thereof. In an embodiment, the one or more esters have a weight average molecular weight equal to or greater than the molecular weight of the starting base fluid. The synthetic esters may be produced via reaction of an alcohol and a carboxylic acid or its equivalent. Carboxylic acid equivalents include carboxylic acid anhydrides, simple carboxylic acid esters, carboxylic acid halides, and combinations thereof. When the alcohol is a primary alcohol, the synthetic ester may be referred to as a primary ester. When the alcohol is a secondary alcohol, the synthetic ester may be referred to as a secondary ester. The synthetic esters may be produced via any suitable method.

In some embodiments, the synthetic esters may be produced via reaction of an olefin with a carboxylic acid. In some embodiments, the olefin is an alpha olefin, an internal olefin, or a mixture thereof. The reaction of alpha olefin or internal olefins with carboxylic acids produce secondary esters. Examples of suitable secondary esters and methods of making same are described in U.S. Pat. Nos. 6,191,076 and 6,100,223, each of which is incorporated by reference herein in its entirety.

In other embodiments, the additive fluid comprises esters of monofunctional alcohols having from 2 to 12 carbon atoms and carboxylic acids having from 16 to 24 carbon atoms. Examples of these esters are described in U.S. Pat. No. 5,232,910, which is incorporated by reference herein in its entirety. The esters may be derived from alcohols and carboxylic acids which are linear, branched, or mixtures thereof. The esters may be derived from carboxylic acids which are saturated, unsaturated, or mixtures thereof. In some embodiments the carboxylic acids are olefinically unsaturated. The unsaturated carboxylic acid may be monounsaturated and/or polyunsaturated.

In yet another embodiment, the additive fluid may comprise a carboxylic acid ester of an alcohol having from 2 to 12 carbon atoms and an aliphatically saturated carboxylic acid having from 12 to 16 carbon atoms. Examples of these esters are described in U.S. Pat. No. 5,252,554, which is incorporated by reference herein in its entirety.

In an embodiment, the additive fluid comprises tetradecyl propionates, hexadecyl propionates, or combinations thereof. In an embodiment, the additive fluid comprises tetradecyl propionates having specifications set forth in Table III. Examples of commercially available additive fluids include RADIAGREEN™ fatty esters available from Oleon NV of Belgium (formerly FINAGREEN™ available from Atofina Oleochemicals), and CHESTER™ 304 tetradecyl propionate ester available from CPChem. The blended fluid may comprise from greater than 0 to about 70 weight percent ester, alternatively from greater than 0 to about 50 weight percent ester, alternatively from greater than 0 to about 35 weight percent ester, alternatively from greater than 0 to about 10 weight percent ester.

TABLE III
Specifications for ChEster ™ 304

| | | TYPICAL |
|---|---|---|
| CHARACTERISTIC | METHOD | VALUE |
| Specific Gravity, 60° F. | ASTM D 287 | 0.86 |
| (15.6° C.) | | |
| Density, lb./gal., 60° F. | | 7.15 |
| (15.6° C.) | | |
| Molecular Weight, g/mole | | 270.5 |
| Viscosity, cSt | | |
| −18° C. (−0.4° F.) | | 30.9 |
| 0° C. (32° F.) | | 13.1 |
| 25° C. (77° F.) | | 5.34 |
| 40° C. (104° F.) | | 3.87 |
| 100° C. (212° F.) | | 1.45 |
| Flash Point, ° F. (° C.) | ASTM D 93 | 316 (158) |
| Pour Point, ° F. (° C.) | ASTM D 97 | −36 (−38) |
| Saponification Number, | ASTM D 94 | 207 |
| (mg KOH/g) | | |
| Acid Value | ASTM D 974 | 0.13 |
| Appearance | Visual | Clear to pale |
| | | straw liquid |

Readily Biodegradable by OECD 301B
Biodegradable by OECD 306

In an embodiment, the additive fluid comprises internal olefins produced via isomerization of synthetic alpha olefins. Such additive fluids may be present in the blended fluid in amounts about equal to those set forth herein for other additive fluids such as esters or IO.

In general, any combination of one or more starting base fluids and one or more additive fluids to form a blended fluid as described herein is contemplated. In an embodiment, the blended fluid has a toxicity of about less than a toxicity of the starting fluid as measured according to ASTM E 1367-92. In an embodiment, the blended fluid has a biodegradability of about equal to or greater than a biodegradability of the starting fluid as measured according to ISO 11734. In yet another embodiment, the blended fluid has a toxicity of about less than a toxicity of the starting fluid as measured according to ASTM E 1367-92 and a biodegradability of about equal to or greater than a biodegradability of the starting fluid as measured according to ISO 11734.

In an embodiment, the blended fluid comprises from about 85 to less than 100 weight percent C_{16/18} internal olefins and from greater than 0 to about 15 weight percent C_{20/24} internal olefins wherein the blended fluid is less toxic than the C_{16/18} internal olefins as measured according to ASTM E 1367-92. In another embodiment, the blended fluid comprises from about 50 to less than 100 weight percent C_{16/18} internal olefins and from greater than 0 to about 50 weight percent esters wherein the blend is less toxic than the C_{16/18} internal olefins as measured according to ASTM E 1367-92.

The blended fluid may have any pour point and/or kinematic viscosity useful in wellbore servicing fluids. In some embodiments, the blended fluid may have a pour point, viscosity, or both about equal to a pour point of the starting base fluid. Alternatively, the blended fluid may have a pour point of equal to or less than about −5° C., alternatively equal to or less than −10° C.; a kinematic viscosity at 40° C. of from about 2 to about 5 cSt; a kinematic viscosity at 100° C. of from about 1 to about 2 cSt; an aromatics content of equal to or less than about 10 ppm by weight; an API at 15.6° C. of equal to or greater than about 40; a specific gravity at 15.6° C. of less than about 0.85; a flash point of greater than about 135° C.; or combinations thereof. In an embodiment, the blended fluid comprises a combination of physical properties such that the blended fluid is functional for use in a drilling fluid, in particular as a drilling fluid in offshore, cold temperature environments.

The blended fluid may be used alone or in combination with other compounds as wellbore servicing fluids. As used herein, “wellbore servicing fluid” refers to a fluid that may be used to prepare a wellbore or a subterranean formation penetrated by the wellbore for the recovery of material from the formation. It is understood that “subterranean formation” encompasses both areas below exposed earth or areas below earth covered by water such as sea or ocean water. Examples of wellbore servicing fluids include but are not limited to a drilling fluid, a work over fluid, a completion fluid, a drill-in fluid, a packer fluid, a coring fluid, or a kill fluid. In an embodiment, the wellbore servicing fluid is a synthetic-based drilling fluid, more specifically an invert emulsion drilling fluid wherein the blended fluid is the continuous phase and water, e.g., brine, is the discontinuous phase.

In addition to the blended fluid, the wellbore servicing fluids may include other additives or conditioning agents as deemed appropriate by one skilled in the art. Such additives may vary depending on the intended function or service of the fluid in the wellbore, for example an invert emulsion drilling fluid. Examples of other additives that the wellbore servicing fluid may contain include weighting agents, emulsifiers, fluid loss control agents, oxidation and corrosion inhibitors, bacteriacides, thinners, wetting agents, viscosifiers, densifiers, and so forth. Such wellbore servicing fluids comprising the blended fluid and other additives may be prepared by known methods and techniques. For example, the other additives used to form a wellbore servicing fluid may be added (i) to a component of the blended fluid, e.g., the starting base fluid or the additive fluid, prior to formation of the blended fluid; (ii) concurrently with or during formation of the blended fluid; (iii) to the blended fluid following formation thereof, for example by mixing the other additives with the blended fluid at a wellbore site; or (iv) combinations thereof. Thus, the various methods of preparing the blended fluid and/or improving the environmental properties thereof may be carried out prior to, concurrently with, and/or after preparation of a wellbore servicing fluid, e.g., an invert emulsion drilling fluid, comprising the blended fluid.

The invention also relates to invert emulsion drilling muds. In an embodiment, the invert emulsion drilling mud comprises a continuous phase comprised of the blended fluid. In another embodiment the invert drilling mud further comprises water and a weighting agent. In additional embodiments the invert drilling mud further comprises one or more additional components selected from weighting agents, emulsifiers, fluid loss control agents, oxidation and corrosion inhibitors, bacteriacides, thinners, wetting agents, viscosifiers, or densifiers.

The invention also relates to a method of making an invert emulsion drilling fluid comprising mixing, in any order, the starting base fluid, one or more additive fluids, a weighting material, and water. The starting base fluid may be any starting base fluid described herein. In some embodiments, the starting base fluid is the reference fluid. In further embodiments, the method further comprises adding in any order emulsifiers, fluid loss control agents, oxidation and corrosion inhibitors, bacteriacides, thinners, wetting agents, viscosifiers, or densifiers known to those skilled in the art. In other embodiment, a blended fluid as described herein is selected and a weighting material and water are added to the selected blended fluid to form an invert emulsion drilling fluid.

Wellbore servicing fluids comprising the blended fluid can be displaced into a wellbore and used to service the wellbore in accordance with procedures known to one skilled in the art. For example, when the blended fluid is used in a drilling fluid, the drilling fluid is circulated down through a hollow drill stem and out through a drill bit attached thereto while rotating the drill stem to thereby drill the wellbore. The drilling fluid also can be flowed back to the surface such that it deposits a filter cake on the wall of the wellbore and carries drill cuttings to the surface.

### EXAMPLES

The invention having been generally described, the following examples are given as particular embodiments of the invention and to demonstrate the practice and advantages thereof. It is understood that the examples are given by way of illustration and are not intended to limit the specification or the claims to follow in any manner.

In various of the following examples, ten day Leptocheirus plumulosus static sediment toxicity tests were performed for various samples of non-aqueous fluids according to ASTM E 1367-92 and values for median lethal concentration (LC₅₀) and toxicity ratio were determined. LC₅₀ is the concentration of a given test sample, in ppm by weight, that is lethal to 50% of the live test organisms under the testing protocol, with increasing values representing decreasing toxicity. Toxicity ratio is the ratio of LC₅₀ for a reference standard sample divided by LC₅₀ for a given test sample, with values greater than 1 indicating that the given test sample is more toxic than the reference standard and values less than 1 indicating that the given test sample is less toxic than the reference standard. The LC₅₀ for a given composition is subject to change from example to example due to normal testing variances. Thus, the toxicity ratio within each example is calculated based on LC₅₀ for a given test sample and reference standard sample that were evaluated at the same time, that is under control conditions.

In various of the following examples, a 275 day anaerobic biodegradation test was performed for various samples of non-aqueous fluids according to ISO 11734 and values for the weight percent degradation of the sample were determined. Unless otherwise indicated, the C_{16/18} IO used in the examples was 65:35 C_{16/18} IO, and the C_{20/24} used in the examples comprised about 1 wt. % C₁₈, about 40 wt. % C₂₀, about 36 wt. % C₂₂, about 22 wt. % C₂₄, and about 1 % C₂₆. NAO designates normal alpha-olefins (i.e., linear 1 -alkenes).

### Examples 1-8

In Examples 1-8, the LC₅₀ was determined for various test samples as detailed in Table IV. Within each example, a general trend of decreasing toxicity with increasing carbon number is shown. Stated alternatively, toxicity decreases as molecular weight of the samples increases in Examples 1-8. Due to test variability relating to the sediment and test organisms, the LC₅₀ are consistent only for the materials within each example. Stated alternatively, direct comparison of the values between one or more examples is not valid due to variability in the sediment and test organism utilized in the toxicity test.

TABLE IV

| EXAMPLE | SAMPLE | COMPOSITION | LC₅₀ (ppm) |
|---|---|---|---|
| 1 | 1 | C₁₈ IO | 4315 |
| | 2 | C_{16/18} IO | 3293 |
| | 3 | C_{16/18} IO | 3120 |
| | 4 | C₁₆ IO | 2032 |
| 2 | 1 | C_{20/24} IO | 9369 |
| | 2 | 85 wt. % C_{16/18} IO/15 | 7541 |
| | | wt. % C_{20/24} IO | |
| | 3 | 90 wt. % C_{16/18} IO/10 | 6875 |
| | | wt. % C_{20/24} IO | |
| | 4 | C₁₈ IO | 6313 |
| | 5 | 95 wt. % C_{16/18} IO/5 | 5756 |
| | | wt. % C_{20/24} IO | |
| | 6 | C₁₈ IO | 4338 |
| | 7 | C_{16/18} IO | 3685 |
| | 8 | C_{16/18} IO | 3434 |
| | 9 | C₁₄ IO | <900 |
| 3 | 1 | C20/24 IO | 8271 |
| | 2 | 95 wt. % C_{16/18} IO/15 | 7807 |
| | | wt. % C_{20/24} IO | |
| | 3 | 90 wt. % C_{16/18} IO/10 | 5954 |
| | | wt. % C_{20/24} IO | |
| | 4 | C_{16/18} IO | 5821 |
| | 5 | 95 wt. % C_{16/18} IO/5 | 5662 |
| | | wt. % C_{20/24} IO | |
| 4 | 1 | C_{16/18} IO | 4285 |
| | 2 | C₁₈ IO | 3461 |
| | 3 | C₁₆ IO | 2935 |
| | 4 | C₁₄ IO | <900 |
| | 5 | C₁₂ NAO | <900 |
| 5 | 1 | 90 wt. % C_{16/18} IO/10 | 8022 |
| | | wt. % C_{20/24} IO | |
| | 2 | 90 wt. % C_{16/18} IO/10 | 7510 |
| | | wt. % C_{20/24} IO | |
| | 3 | C_{16/18} IO | 6876 |
| 6 | 1 | C₁₆ propionates | 2661 |
| | | (secondary C₁₆ esters) | |
| | 2 | 50 wt. % C₁₆ ester/50 | 1300 |
| | | wt. % C_{16/18} IO | |
| | 3 | 50 wt. % C₁₆ ester/50 | 1288 |
| | | wt. % C₁₆ IO | |
| | 4 | C_{16/18} IO | 714 |
| 7 | 1 | C_{16/18} IO | 1268 |
| | 2 | C₁₆ propionates | 2996 |
| | | (secondary C₁₆ esters) | |
| 8 | 1 | C_{16/18} IO | 1632 |
| | 2 | 50 wt. % secondary | 2162 |
| | | C₁₆ esters/50 wt. % C_{16/18} IO | |

### Examples 9-16

In Examples 9-16, toxicity ratio was determined for various test samples as detailed in Table V. Across the examples, there is a general trend of increased toxicity for compounds having less carbon atoms than the reference standard (i.e., lighter compounds) and decreased toxicity for compounds having more carbon atoms than the reference standard (i.e., heavier compounds). Stated alternatively, toxicity decreases as molecular weight of the samples increases with respect to the reference standard, and toxicity increases as molecular weight of the samples decreases with respect to the reference standard. The toxicity ratio for the samples within examples 13 show the variability of the toxicity test method and the variability of manufactured C_{16/18} IO product as the materials tested in example 13 represent several different batches of the C_{16/18} IO product manufactured at different times.

TABLE V

| | | | LC₅₀ of C_{16/18} IO/LC₅₀ of sample | | |
|---|---|---|---|---|---|
| EXAMPLE | SAMPLE | COMPOSITION | Ratio | Averages | St. dev. s. |
| 9 | 1 | C₁₂ NAO | >3.33 | 0.25 | 1.684 |
| 10 | 1 | C₁₄ IO | 3.33 | | |
| | 2 | C₁₄ IO | 3.33 | | |
| | 3 | C₁₄ NAO | 6.25 | | |
| 11 | 1 | C_{14/16} NAO (65:35 by wt.) | 2.50 | | |
| 12 | 1 | C₁₆ IO | 1.54 | 1.17 | 0.519 |
| | 2 | C₁₆ IO | 0.80 | | |
| 13 | 1 | C_{16/18} IO | 1.30 | 0.87 | 0.187 |
| | 2 | C_{16/18} IO | 1.00 | | |
| | 3 | C_{16/18} IO | 1.00 | | |
| | 4 | C_{16/18} IO | 1.00 | | |
| | 5 | C_{16/18} IO | 1.00 | | |
| | 6 | C_{16/18} IO | 0.93 | | |
| | 7 | C_{16/18} IO | 0.91 | | |
| | 8 | C_{16/18} IO | 0.91 | | |
| | 9 | C_{16/18} IO | 0.85 | | |
| | 10 | C_{16/18} IO | 0.75 | | |
| | 11 | C_{16/18} IO | 0.75 | | |
| | 12 | C_{16/18} IO | 0.70 | | |
| | 13 | C_{16/18} IO | 0.66 | | |
| | 14 | C_{16/18} IO | 0.65 | | |
| | 15 | C_{16/18} IO | 0.55 | | |
| | 16 | C_{16/18} IO | 1.00 | | |
| 14 | 1 | C₁₈ IO | 0.79 | 0.59 | 0.195 |
| | 2 | C₁₈ IO | 0.72 | | |
| | 3 | C₁₈ IO | 0.59 | | |
| | 4 | C₁₈ IO | 0.54 | | |
| | 5 | C₁₈ IO | 0.29 | | |
| 15 | 1 | C_{20/24} IO | 0.37 | 0.40 | 0.164 |
| | 2 | C_{20/24} IO | 0.58 | | |
| | 3 | C_{20/24} IO | 0.26 | | |
| 16 | 1 | 95 wt. % C_{16/18} IO/5 wt. % C_{20/24} IO | 0.60 | 0.52 | 0.072 |
| | 2 | 90 wt. % C_{16/18} IO/10 wt. % C_{20/24} IO | 0.50 | | |
| | 3 | 85 wt. % C_{16/18} IO/15 wt. % C_{20/24} IO | 0.45 | | |

### Example 17

In Example 17, viscosity, flash-fire point, pour point, API, and specific gravity were determined by standard, acceptable methods for various test samples as detailed in Table VI. This example shows that blended fluid produced as described herein exhibit acceptable physical properties for use in wellbore servicing fluids. Sample 7 provides comparative data for C_{16/18} IO widely considered as acceptable.

TABLE VI

| | | | | | | Flash- | | | Specific |
|---|---|---|---|---|---|---|---|---|---|
| | | | | | | Point | Pour | API | Gravity |
| | | Viscosity | | | | COC | Point | (60 F./ | (60 F./ |
| SAMPLE | Composition | 0 C. | 25 C. | 40 C. | 100 C. | (deg C.) | (deg C.) | 15.6 C.) | 15.6 C.) |
| 1 | 95 wt. % C_{16/18} IO/5 wt. % C_{20/24} IO | 8.61 | 4.13 | 3.03 | 1.29 | 146 | −16 | 47.7 | 0.7885 |
| 2 | 90 wt. % C_{16/18} IO/10 wt. % C_{20/24} IO | 9.14 | 4.28 | 3.14 | 1.32 | 148 | −13 | 47.2 | 0.7895 |
| 3 | 85 wt. % C_{16/18} IO/15 wt. % C_{20/24} IO | 9.67 | 4.46 | 3.26 | 1.36 | 145 | −10 | 47.2 | 0.7903 |
| 4 | 50 wt. % C_{16/18} IO/50 wt. % ChEster 304 | 10.31 | 4.57 | 3.27 | 1.32 | 153 | −28 | 40.8 | 0.8217 |
| 5 | 50 wt. % C₁₆ IO/50 wt. % ChEster 304 | 9.52 | 4.27 | 3.09 | 1.27 | 147 | −34 | 40.8 | 0.8201 |
| 6 | C₁₆ Ester (secondary C₁₆ propionates) | 21.33 | 10.51 | 6.64 | 2.29 | 181 | −18 | 33.5 | 0.8577 |
| 7 | C_{16/18} IO | 7.93 | 3.95 | 2.86 | 1.29 | 145 | <−10 | 47.91 | 0.7887 |

### Example 18

In Example 18, weight percent degradation was determined for various test samples as detailed in Table VII. The weight percent of branched material in each sample was determined by a known procedure comprising hydrogenation of an equivalent sample and analyzing the resultant hydrogenated product via gas chromatography. This example shows that weight percent degradation increases with decreasing amounts, e.g., weight percent, of branched material in a sample. Stated alternatively, olefins having low amounts of branching biodegrade more readily than olefins having high amounts of branching.

TABLE VII

| | | | wt. % Degraded |
|---|---|---|---|
| SAMPLE | COMPOSITION | wt. % Branched | after 275 days |
| 1 | C₁₆ NAO | 8.0 | 67.18 |
| 2 | C₁₆ IO | 10.4 | 67.33 |
| 3 | C_{16/18} IO | 11.0 | 70.66 |
| 4 | C_{16/18} IO | 48.0 | 42.57 |
| 5 | C_{16/18} IO | 29.0 | 55.08 |
| 6 | C₁₈ IO | 68.0 | 30.70 |

### Example 19

In Example 19, weight percent degradation was determined for various test samples as detailed in Table VIII. This sample shows that the addition of esters to C_{16/18} IO increases the biodegradability thereof.

TABLE VIII

| | | wt. % | wt. % | LC₅₀ | LC₅₀ | |
|---|---|---|---|---|---|---|
| | | C_{16/18} IO | Sample | Sample | C_{16/18} IO | Toxicity |
| SAMPLE | COMPOSITION | Degraded | Degraded | (ppm) | (ppm) | Ratio |
| 1 | 50% C_{16/18} IO, 50% C₁₄ propionates (C₁₄ esters) | 45.19 | 64.72 | 1075 | 1047 | 0.97 |
| 2 | 50% C_{16/18} IO, 50% C₁₄ propionates (C₁₄ esters) | 55.08 | 72.28 | 1929 | 1767 | 0.92 |
| 3 | 50% C_{16/18} IO, 50% C₁₆ propionates (C₁₆ esters) | 45.19 | 65.28 | 1288 | 714 | 0.55 |

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the preferred embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What we claim as our invention is:

1. A method of decreasing a toxicity, as determined according to ASTM E 1367-92, of a non-aqueous fluid for use in a wellbore servicing fluid, comprising:
(a) providing a starting non-aqueous fluid having a toxicity of about equal to or greater than a toxicity of a reference standard non-aqueous fluid;
(b) adding an effective amount of one or more additive non-aqueous fluids to the starting non-aqueous fluid to produce a blended non-aqueous fluid having a toxicity of less than the toxicity of the reference standard non-aqueous fluid.

2. The method of claim 1 wherein the blended fluid has a biodegradability of about equal to or greater than a biodegradability of the reference standard fluid as measured according to ISO 11734.

3. The method of claim 1 wherein the starting fluid comprises C₁₆ internal olefins, C₁₈ internal olefins, or combinations thereof.

4. The method of claim 1 wherein the starting fluid comprises about 65 weight percent C₁₆ internal olefins and about 35 weight percent C₁₈ internal olefins.

5. The method of claim 1 wherein the starting fluid and the reference standard fluid are the same.

6. The method of claim 5 wherein the starting fluid and the reference standard fluid each comprise about 65 weight percent C₁₆ internal olefins and about 35 weight percent C₁₈ internal olefins.

7. The method of claim 1 wherein the additive fluid comprises one or more internal olefins, esters, or combinations thereof

8. The method of claim 1 wherein the additive fluid comprises a weight average molecular weight greater than the starting fluid.

9. The method of claim 1 wherein the additive fluid comprises C₂₀ internal olefins, C₂₂ internal olefins, C₂₄ internal olefins, or combinations thereof.

10. The method of claim 6 wherein the additive fluid comprises C₂₀ internal olefins, C₂₂ internal olefins, C₂₄ internal olefins, or combinations thereof.

11. The method of claim 1 wherein the additive fluid comprises about 35 to about 55 weight percent C₂₀ internal olefins, about 25 to about 45 weight percent C₂₂ internal olefins, and about 8 to about 30 weight percent C₂₄ internal olefins.

12. The method of claim 10 wherein the additive fluid comprises about 35 to about 55 weight percent C₂₀ internal olefins, about 25 to about 45 weight percent C₂₂ internal olefins, and about 8 to about 30 weight percent C₂₄ internal olefins.

13. The method of claim 1 wherein the additive fluid comprises equal to or less than about 35 weight percent branched olefins.

14. The method of claim 1 wherein the blended fluid comprises from greater than 0 to about 20 weight percent C_{20/24} internal olefins.

15. The method of claim 12 wherein the blended fluid comprises from greater than 0 to about 20 weight percent C_{20/24} internal olefins.

16. The method of claim 1 wherein the additive fluid comprises one or more esters.

17. The method of claim 1 wherein the additive fluid comprises one or more primary esters, secondary esters, or combinations thereof.

18. The method of claim 1 wherein the additive fluid comprises tetradecyl propionates, hexadecyl propionates, or combinations thereof.

19. The method of claim 16 wherein the blended fluid comprises greater than 0 to about 70 weight percent ester.

20. The method of claim 1 further comprising adding one or more wellbore servicing fluid components to the starting fluid, the additive fluid, the blended fluid, or combinations thereof to form the wellbore servicing fluid.

21. The method of claim 1 wherein the wellbore servicing fluid is a drilling fluid.

22. The method of claim 1 wherein the wellbore servicing fluid is an invert emulsion drilling fluid having a continuous phase comprising the blended fluid.

23. A method of blending a non-aqueous base fluid for an invert emulsion drilling fluid, comprising:
(a) providing a starting non-aqueous fluid; and
(b) adding one or more additive non-aqueous fluids to the starting non-aqueous fluid to produce a blended non-aqueous fluid; wherein
(i) the one or more additive non-aqueous fluids has a molecular weight of equal to or greater than a molecular weight of the starting non-aqueous fluid; and
(ii) the blended non-aqueous fluid has a biodegradability of about equal to or greater than a biodegradability of the starting non-aqueous fluid as measured according to ISO 11734.

24. The method of claim 23 wherein the blended fluid has a toxicity of about less than a toxicity of the starting fluid as measured according to ASTM E 1367-92.

25. A method of improving environmental performance of a non-aqueous base fluid for an invert emulsion offshore drilling fluid, comprising:
(a) providing a starting non-aqueous fluid; and
(b) adding one or more additive non-aqueous fluids to the starting non-aqueous fluid to produce a blended non-aqueous fluid; wherein
(i) the blended non-aqueous fluid has a toxicity of about less than a toxicity of the starting non-aqueous fluid as measured according to ASTM E 1367-92; and
(ii) the blended non-aqueous fluid has a biodegradability of about equal to or greater than a biodegradability of the starting non-aqueous fluid as measured according to ISO 11734.

26. A method of blending a non-aqueous base fluid for an invert emulsion drilling fluid, comprising:
(a) providing a neat non-aqueous fluid consisting essentially of C_{16/18} internal olefins; and
(b) adding an effective amount of C_{20/24} internal olefins to the neat non-aqueous fluid such that a resultant blended non-aqueous fluid is less toxic than the neat non-aqueous fluid as measured according to ASTM E 1367-92.

27. A method of decreasing the toxicity of a non-aqueous base fluid for an invert emulsion drilling fluid, comprising:
(a) determining a baseline toxicity according to ASTM E 1367-92 for a non-aqueous base fluid consisting essentially of C_{16/18} internal olefins; and
(b) adding an effective amount of C_{20/24} internal olefins to the non-aqueous base fluid such that a resultant blended non-aqueous fluid is less toxic than baseline toxicity of the non-aqueous base fluid.

28. A non-aqueous fluid blend for use as a continuous phase in an invert emulsion drilling fluid, comprising:
from about 85 to less than 100 weight percent C_{16/18} internal olefins; and
from greater than 0 to about 15 weight percent C_{20/24} internal olefins,
wherein the blend is less toxic than the C_{16/18} internal olefins as measured according to ASTM E 1367-92.

29. The non-aqueous fluid blend of claim 28 wherein the non-aqueous fluid blend has a biodegradability of about equal to or greater than a biodegradability of the C_{16/18} internal olefins as measured according to ISO 11734.

30. An invert emulsion drilling fluid comprising the non-aqueous fluid blend of claim 28.

31. The blended non-aqueous fluid produced by the process of claim 1.
